(19) United States
(12) Patent Application Publication
(10) Pub. No.: US 2006/0062127 A1
(43) Pub. Date: Mar. 23, 2006

(54) Device and method for homogenising laser radiation and laser system using such a device and such a method

(76) Inventors: Berthold Burghardt, Waake (DE); Herning Schmidt, Gottingen (DE); Peter Oesterlin, Gottingen (DE); Klaus Brunwinkel, Gottingen (DE)

Correspondence Address: STRAUB & POKOTYLO, 620 TINTON AVENUE, BLDG. B, 2ND FLOOR, TINTON FALLS, NJ, 07724, US

(21) Appl. No.: 11/207,981

(22) Filed: Aug. 19, 2005

(30) Foreign Application Priority Data
Sep. 1, 2004 (DE) 10 2004 042 337.7

(51) Int. Cl. G11B 7/00

(52) U.S. Cl. 369/121

(57) ABSTRACT

In a device and a method for homogenising laser radiation with a homogeniser, the relative position and/or direction between the laser radiation and the homogeniser or an effect of the homogeniser is measured in order to adjust the said relative position and/or direction as a function of the measurement signal.

The invention relates to a device and a method for homogenising laser radiation, and to a laser system in which such a device or such a method are used.

### 1) PRIOR ART

The processing of surfaces of workpieces by lasers generally requires large-area illumination of the surface with the laser beam. In this context, it is possible to achieve effects such as cleaning (used in the semiconductor industry), chemical reactions with ambient gas can be initiated, or surface modifications can be induced by melting and resolidifying. Examples of this include the hardening of metal surfaces and, in particular, the crystallisation of amorphous silicon layers. Continuous-wave or pulsed lasers may be used, depending on which type of laser achieves the best effect.

Important parameters are:
the wavelength of the laser radiation (this determines the absorption and therefore the penetration depth of the light into the material)
the intensity or power density (this determines the effect, for example heating or melting)
the duration for which the laser beam acts (this determines how long the surface layer is heated or kept liquid and how far the heat penetrates by thermal conduction into the unirradiated or deeper regions)

The wavelength must be matched to the absorption of the material which is intended to be processed. Since superficial modifications are involved, the laser light must be absorbed in a thin layer. For each material, the wavelength of the laser must be found so that the radiation cannot penetrate more deeply than the layer thickness which is intended to be heated or melted.

The duration for which the laser beam acts on the surface has an influence on the physical properties of the modified surface. Moreover, it also determines how far the heat propagates in the material by thermal conduction and therefore influences regions which are not directly exposed to the laser beam but are nearby.

The optimum intensity of the laser radiation is determined according to several factors. These include the temperature which is intended to be reached in the material, the time for which the laser beam acts on the surface, and the thermal dissipation into neighbouring regions of the material. The intensity is determined by the power of the laser and by the area over which the laser beam is distributed often, a particular application has only a small range within which the intensity may vary in order to achieve the desired result. The irradiation with laser light must then take place very uniformly.

It is consequently advantageous to use a laser beam with a uniform (homogeneous) intensity distribution. If the laser beam has so high an intensity that a surface to be processed can be processed as a whole, i.e. at the same time, then the laser beam must be homogeneous within the area to be processed. If the beam is small, because its intensity is sufficient for processing only a part of the overall surface, then various methods are available for gradually processing the entire surface.

One method is stepwise processing. After processing a part of the surface, a laser beam which has a certain size determined by its intensity is deviated to the next point, which is then processed. The entire surface is hence covered stepwise. The laser beam thus steps to the next processing site and remains there for a particular duration, before this process is repeated. This method is therefore known in the technical world as the “step & repeat” method. As an alternative to deviating the laser beam, the workpiece may also be displaced.

In the scanning method, a laser beam is moved continuously over the surface. It does not then remain at one site, but generates its effect on the surface during the movement. This movement often takes place with a constant speed. If different effects are intended to be induced at various sites on the surface, or if some sites require a different overall dose of laser radiation than others, for example because more heat is dissipated in the middle of a part than at the edge and more energy therefore has to be supplied in the middle in order to reach the same temperature, then the speed at which the laser beam is moved may also be varied.

A common feature of all the methods is that the laser radiation has a homogeneous intensity distribution within its cross section (the area which it illuminates at a given time). Only then is it possible to achieve an effect which is uniform over the entire surface. Both for processing the entire surface in one go and for the step & repeat method, the laser beam must be homogenised in both dimensions (length and width).

The same beam profile can be used for the scanning method. It may, however, be preferable to use a laser beam with an intensity distribution which is uniform only in one dimension, i.e. length. In the other dimension, i.e. width, the intensity distribution is bell-shaped, for example a Gaussian distribution. For scanning, such a beam offers the advantage that the effect is more uniform in the scanning direction, especially when pulsed lasers are used.

A common feature of both methods is that the laser beam must have a homogeneous intensity distribution in at least one dimension. However, lasers do not normally emit homogeneous radiation but have an intensity maximum in the middle and fall off towards the edge. Such lasers often have a Gaussian intensity distribution in the beam:
I=I₀×e^{-a}, with a=r²/2r₀².

This means that the intensity is maximal on the optical axis (I=I₀) and decreases as the length r from the optical axis increases. At r=2r₀, it has fallen to the value I=I₀/e²˜I₀/7.39. This distance from the optical axis is often also defined as the beam cross section (diameter d=4r₀). Solid-state lasers such as Nd:YAG lasers are a typical example of such lasers. They emit laser radiation in the infrared spectral range (1064 nm) or, when frequency multiplication is used, in the green or UV range (532 nm, 355 nm, 266 nm).

Often, such an intensity distribution cannot be used for surface processing.

Assistance can be offered by so-called diffractive optical elements (DOEs). These are plates of transparent material in which one surface is structured on the μm scale. The structuring is configured so that the transmitted light is specifically influenced with respect to its propagation direction at each site. The effect of a DOE may either be based on interferences which neighbouring light rays generate with one another, or it may be based on different deviation of the light rays at each site. DOEs are extensively described in the literature, for example in “Digital Diffractive Optics: An Introduction to Planar Diffractive Optics and Related Technology” by B. Kress and P. Meyrueis, John Wiley & Sons; 1^{st} edition (Oct. 25, 2000).

In general, a system of diffractive optical elements (DOEs) generates a substantially perfect rectangular shape of the intensity distribution, which is known as a “top-hat distribution”, from the bell-shaped initial distribution.

A disadvantage of many homogenisers, and in particular DOEs, is the fact that the homogenisation result depends very sensitively on the relative position between the laser radiation and the homogeniser. In the case of a DOE, for example, shifting the laser beam by only 50 μm leads to significant tilting of the flat part of the intensity distribution, i.e. laser radiation is consequently generated which has a substantially lower intensity on one side of the beam than on the opposite side of the beam, that is to say the intensity profile extends obliquely. The radiation leaving the homogeniser is thus asymmetric with respect to the central beam axis. This asymmetry occurs in at least one plane.

A dependency of the homogenisation result on the relative position and orientation of the laser beam incident on the homogeniser may also occur in other homogenisers, for example in a gap homogeniser.

Aspherical telescopes, which are likewise used as homogenisers, may also react very sensitively to the beam position and direction. Aspherical telescopes expand the laser beam. In this case, lenses with aspherically ground surfaces are used so that the expansion of the beam is large at the centre and small at the edge. The high intensity in the middle of the beam is thus distributed over a large area, and the low intensity at the edge is distributed over a small area. With skilful design of the aspherical lenses, a field with a homogeneous intensity distribution is generated at a particular distance. Such aspherical telescopes are commercially available, for example the “Beam Shaper” from Newport Corporation, Irvine, Calif., USA. The sensitivity of these telescopes to the position and direction of the incident beam is known. It is of a similar magnitude as in the aforementioned DOE.

It is an object to the invention to provide a device and a method for homogenising laser radiation, with which the homogenisation results in homogenisers can be reliably improved so that, in particular, the working results can be improved with respect to quality and consistency when processing e.g. workpieces. In particular, the device and method according to the invention should also offer quality and consistency of the working result when crystallising amorphous silicon layers.

In order to achieve these objects, the invention relates to a device for homogenising laser radiation with a homogeniser, which has the following:
a measuring instrument for measuring the relative position and/or direction of the laser radiation with respect to the homogeniser or for measuring an effect of the homogeniser, and
an instrument for changing the relative position and/or direction between the laser radiation and the homogeniser as a function of the result of the measurement.

The method according to the invention is distinguished by
measurement of the relative position and/or direction of the laser radiation with respect to the homogeniser or measurement of an effect of the homogeniser in order to derive a measurement signal, and
changing of the relative position and/or direction between the laser radiation and the homogeniser according to the measurement signal.

The laser system according to the invention uses a device of the said type and employs the said method.

According to a preferred refinement of the invention, the measuring instrument measures a symmetry property of the radiation leaving the homogeniser as an effect of the homogeniser.

For example, if an inadvertent change in the relative position between the laser radiation and the homogeniser causes an undesirable asymmetric intensity distribution of the (now only partially) homogenised radiation in the aforementioned sense, then this asymmetry of the intensity distribution can be measured quite easily (by measuring the intensities at least at two sites of the beam) and a very sensitive control signal can be derived from this measurement in order to change the relative position between the laser radiation and the homogeniser in the context of feedback, in such a way as to finally restore the desired homogenisation result by changing the relative position between the radiation and the homogeniser. This may be done fully automatically under the control of a computer.

On the other hand, it is possible to measure the position and/or direction between the incident laser radiation and the homogeniser directly, which is to say, with a stationary homogeniser, the beam position and the beam direction are measured by means which are known per se in the radiation path before the homogeniser. Changes in the beam position and/or beam direction, which may be due to fluctuations in the laser, can then be compensated for directly by means of feedback control so that the laser radiation striking the homogeniser accurately and constantly has the desired position and direction.

In the aforementioned sense, the term “position” describes a coordinate in a coordinate system which is perpendicular to the laser radiation axis, and the term “direction” corresponds to a vector according to which the laser radiation propagates in space.

According to a preferred refinement of the invention, the relative position and/or direction between the laser radiation and the homogeniser is adjusted in the said feedback loop by adjusting one or more mirrors in the beam path of the laser radiation before the homogeniser, according to the measurement result.

On the other hand, it is also possible to adjust the relative position and/or direction between the laser radiation and the homogeniser by moving the homogeniser, or a part of it, with respect to the laser radiation, for example displacing it transversely to the laser radiation and/or tilting it with respect to the laser radiation direction.

Overall, the invention provides an actively stabilised homogeniser which is preferably used for highly coherent laser radiation in laser systems.

Exemplary embodiments of the invention will be explained in more detail below with reference to the drawings, in which:

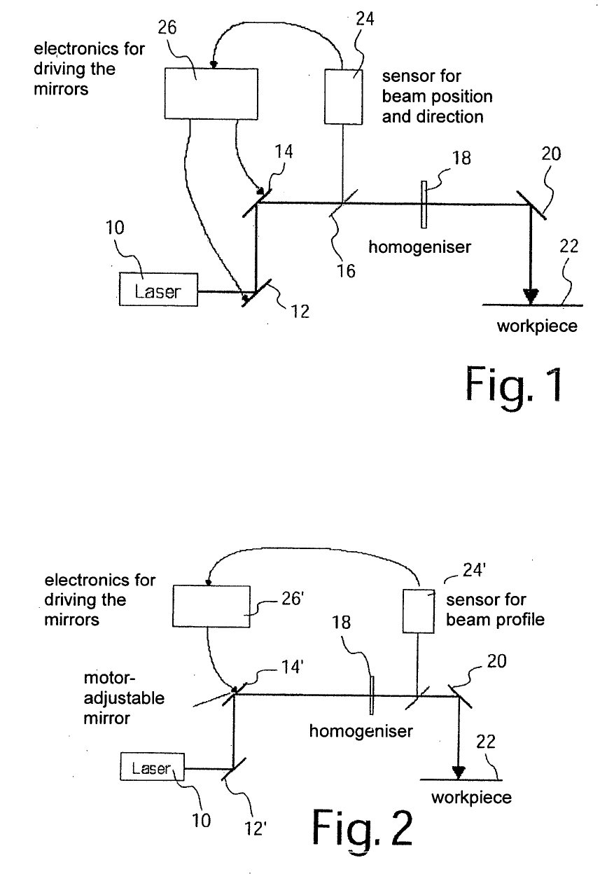

FIGS. 1 to 3 show exemplary embodiments of homogenisers; and

FIG. 4 shows a laser system using a homogeniser according to one of FIGS. 1 to 3.

In the figures, elements which are functionally equivalent or functionally similar to one another are provided with the same references, where appropriate suffixed by a prime.

FIG. 1 shows an actively stabilised homogeniser for laser radiation, which is emitted by a laser 10.

A workpiece 22 is intended to be processed in the aforementioned sense by this laser radiation.

The laser radiation emitted by the laser 10 is deviated via mirrors 12, 14 and directed via a beam splitter 16 onto a homogeniser 18. The homogeniser may be of a type such as mentioned in the introduction, for example an aforementioned DOE. Both the beam position and the beam direction with respect to the homogeniser 18 should be kept stable, even if the beam positions and directions change for whatever reason, particularly fluctuations in the laser itself. To this end, a small part of the laser radiation is separated from the beam by the beam splitter 16, and directed onto a measuring device 24 which can measure both the beam position and the beam direction. For example, the “AlignMeter” device available on the market from Melles Griot, Carlsbad, Calif., USA is suitable for this. The measuring instrument 24 thus delivers a measurement signal which indicates whether the laser beam has departed from a predetermined setpoint position and setpoint direction on the way to the homogeniser 18. A corresponding measurement signal is sent from the measuring device 24 to the electronics 26 which control one or both deviating mirrors 12, 14, i.e. move them using motors, in order to adjust the beam position as a function of the measurement result independently in the x and y directions in a coordinate system perpendicular to the beam axis, as well as the direction of the radiation, so that the predetermined setpoint values are again achieved with respect to position and direction.

Highly stabilised, homogenised radiation therefore leaves the homogeniser 18 and is directed via a deviating mirror 20 onto the workpiece 22.

The beam position and direction with respect to the homogeniser 18 are not measured directly by a sensor in the exemplary embodiment according to FIG. 2, but instead the result of the homogenisation is measured after the homogeniser so as to indirectly find any change in the beam position and/or beam direction. As mentioned above, a change in the beam position and/or beam direction in homogenisers, for example in a DOE, leads to a change of the symmetry in the intensity distribution of the radiation leaving the homogeniser. If a small part of the radiation leaving the homogeniser is directed by a beam splitter onto the measuring device 24′, therefore, then an oblique intensity distribution in the aforementioned sense can be found, for example by measurement on two opposite sides of the beam, and from this it is possible to derive a measurement signal and deliver it to electronics 26′ which derive control signals for a motor-adjustable mirror 14′ therefrom. In the exemplary embodiment according to FIG. 2, the electronics 26′ control only one of the mirrors 12′, 14′ since, as a function of the laser and other parameters, it may be possible to control the laser radiation with respect to position and direction with only one mirror (here 14′) in such a way that the homogenisation result remains stable.

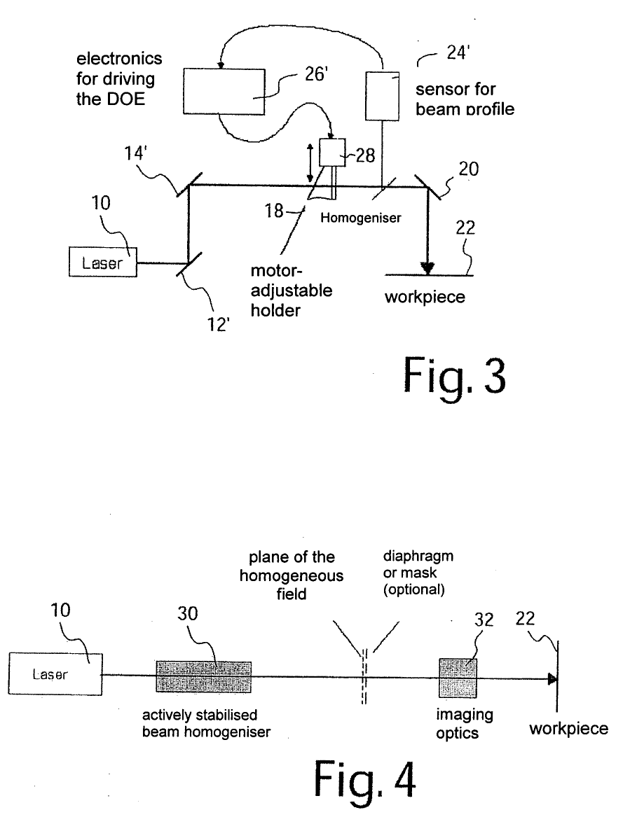

FIG. 3 shows a variant of the exemplary embodiments described above, in so far as the position and/or direction of the laser beam striking the homogeniser 18 is not adjusted by means of at least one mirror, but instead the homogeniser 18 (or a part of it) is adjusted with respect to the radiation. To this end, in accordance with the exemplary embodiment according to FIG. 2, the beam splitter separates a part of the homogenised beam and directs it onto a measuring device 24′ for measuring the beam profile, and a corresponding measurement signal is sent to electronics 26′ which derive a control signal for driving an instrument 28 capable of adjusting the homogeniser 18 (or a part of it) so that the relative position and/or direction between the laser radiation and the homogeniser 18 thereupon has exactly the desired setpoint value.

Very long-term stability of the homogenisation can be achieved with the systems for homogenising laser radiation as described above with reference to FIGS. 1 to 3, for example over operating times of hours, days or even weeks.

In the exemplary embodiments of the invention as described with reference to FIGS. 1 to 3, the plane in which the homogeneous illumination field is denoted by “workpiece 22”. In principle, the plane in which the homogeneous illumination field occurs is formed may also be a plane which is optically imaged onto a workpiece (this will be explained below with reference to FIG. 4). The position 22 in FIGS. 1 to 3 may therefore also be referred to as the plane in which the homogeneous field is generated.

FIG. 4 shows a laser system using an actively stabilised beam homogeniser 30, in particular according to one of Figures 1, 2 and 3. The laser system optionally has a diaphragm or mask, which is arranged in the plane of the homogeneous field (in FIG. 4, the diaphragm or mask and the planes of the homogeneous field are mutually offset slightly for representation reasons). Between the actively stabilised beam homogeniser 13 and the workpiece 22 to be processed, imaging optics 32 are arranged in order to image the homogeneous plane or optionally the diaphragm or mask onto the surface to be processed on the workpiece 22. The mirrors conventionally provided for deviating and aligning laser radiation are not depicted in the representation.

In the laser system shown in FIG. 4, a sensor (corresponding to the sensor 24 according to FIG. 1) may be arranged directly on the beam homogeniser 13 or, on the other hand, preferably in the plane 22 of the workpiece. In this case, a beam splitter (similar to the beam splitter 16 according to FIG. 1) would then be arranged between the imaging optics 32 and the workpiece 22. Such an arrangement would, in particular, have the advantage that the homogeniser can compensate for distortions of the intensity distribution which are due to the imaging optics.

1. Device for homogenising laser radiation comprising:
a homogeniser (18) which the laser radiation strikes,
a measuring instrument (24: 24′) for measuring the relative position and/or direction of the laser radiation with respect to the homogeniser or for measuring an effect of the homogeniser, and
an instrument (26; 26′) for changing the relative position and/or direction between the laser radiation and the homogeniser as a function of the result of the measurement.

2. Device according to claim 1, wherein the measuring instrument (24′) measures a symmetry property of the radiation leaving the homogeniser (18) as an effect of the homogeniser (18).

3. Device according to claim 1, further comprising:
one or more mobile mirrors (12, 14; 12′, 14′) movably arranged in the beam path of the laser radiation before the homogeniser (18) for changing the relative position and/or direction between the laser radiation and the homogeniser.

4. Device according to claim 2, further comprising:
an instrument (28) for moving the homogeniser, or part of it, is provided in order to change the relative position and/or direction between the laser radiation and the homogeniser.

5. Method for homogenising laser radiation with a homogeniser (18) at which the laser radiation is directed, comprising:
measurement of the relative position and/or direction of the laser radiation with respect to the homogeniser or measurement of an effect of the homogeniser in order to derive a measurement signal, and
changing of the relative position and/or direction between the laser radiation and the homogeniser according to the measurement signal.

6. Method according to claim 5, further comprising:
measuring, as an effect of the homogeniser (18), a symmetry property of the radiation leaving the homogeniser.

7. Method according to claim 5, further comprising:
adjusting using one or more adjustable mirrors (12, 14; 12′, 14′), the relative position and/or direction between the laser radiation and the homogeniser.

8. Method according to claim 5, further comprising:
adjusting the homogeniser, or a part of it to change the relative position and/or direction between the laser radiation and the homogeniser.

9. Laser system for processing a workpiece (22) with a device according claim 1.

10. Laser system according to claim 9, further comprising:
a mask or diaphragm in a plane between the homogeniser (30) and the workpiece (22) in the plane of the homogeneous field of the laser radiation.

11. Laser system according to claim 9, further comprising:
imaging optics (32) for imaging the homogeneous plane or the diaphragm or mask onto the surface to be processed on the workpiece (22).

12. Device according to claim 2, further comprising:
one or more mobile mirrors (12, 14; 12′, 14′) movably arranged in the beam path of the laser radiation before the homogeniser (18) for changing the relative position and/or direction between the laser radiation and the homogeniser.

13. Device according to claim 3, further comprising:
an instrument (28) for moving the homogeniser, or part of it, is provided in order to change the relative position and/or direction between the laser radiation and the homogeniser.

14. Method according to claim 6, further comprising:
adjusting using one or more adjustable mirrors (12, 14; 12′, 14′), the relative position and/or direction between the laser radiation and the homogeniser.

15. Method according to claim 6, further comprising:
adjusting the homogeniser, or a part of it to change the relative position and/or direction between the laser radiation and the homogeniser.

16. Method according to claim 7, further comprising:
adjusting the homogeniser, or a part of it to change the relative position and/or direction between the laser radiation and the homogeniser.

17. Laser system according to claim 10, further comprising:
imaging optics (32) for imaging the homogeneous plane or the diaphragm or mask onto the surface to be processed on the workpiece (22).
